(19) United States
(12) Patent Application Publication
(10) Pub. No.: US 2024/0106360 A1
(43) Pub. Date: Mar. 28, 2024

(54) METHOD FOR REDUCING ELECTROMAGNETIC VIBRATION OF PERMANENT MAGNET MOTOR WITH FRACTIONAL SLOT CONCENTRATED WINDING

(71) Applicant: Jiangsu University, Jiangsu (CN)

(72) Inventors: Wenxiang ZHAO, Jiangsu (CN); Shengdao ZHU, Jiangsu (CN); Guohai LIU, Jiangsu (CN); Jinghua JI, Jiangsu (CN)

(73) Assignee: Jiangsu University, Jiangsu (CN)

(21) Appl. No.: 18/038,215

(22) PCT Filed: Mar. 2, 2021
(86) PCT No.: PCT/CN2021/078611

§ 371 Date: May 23, 2023

(30) Foreign Application Priority Data
Feb. 24, 2021 (CN) 202110206198.9

(51) Int. Cl. H02P 21/05; H02K 1/276; H02P 21/14

(52) U.S. Cl. CPC H02P 21/05; H02K 1/2766; H02P 21/141; H02K 2213/03; H02P 21/0017

(57) ABSTRACT

The present disclosure provides a method for reducing the electromagnetic vibration of a fractional slot concentrated winding (FSCW) permanent magnet (PM) motor, which provides a guidance for the low vibration design of FSCW PM motor. The implementation of the method includes: Based on Nyquist Shannon sampling theorem, the modulation effect of electromagnetic force in the air gap is obtained, and the electromagnetic force component that contributes the most to the electromagnetic vibration of the FSCW PM motor is determined. The equivalent analytical model of PM flux density is established to obtain the phase relationship between different flux density harmonics. According to Maxwell stress equation, the internal relationship between each order of flux density harmonics and electromagnetic force harmonics is obtained. A new magnet structure of the PM motor is designed, and specific flux density harmonics are injected to reduce the electromagnetic force and electromagnetic vibration of the FSCW PM motor.

### TECHNICAL FIELD

The present disclosure relates to a design and manufacture method of permanent magnet (PM) motors, and in particular, to a method for reducing the electromagnetic vibration of the fractional slot concentrated winding (FSCW) PM motor.

### BACKGROUND

The FSCW PM motor has the advantages of high efficiency, high power density, wide speed range, low torque ripple and strong fault tolerance. It has been widely used in the fields of aerospace, electric vehicles, ship propulsion systems. With the development of PM motor industry, various applications put forward higher requirements on the performance of PM motor, and the electromagnetic vibration issue has received great attention from researchers. In particular, the FSCW PM motor has a special winding structure, and there are abundant magnetic field and electromagnetic force harmonic components in the air gap. The electromagnetic vibration problem of the FSCW PM motor seriously restricts its application in automobiles, household appliances, medical devices and other applications. Therefore, it is of great practical significance to study the electromagnetic vibration and its excitation source of PM motor for improving the comprehensive performance and product competitiveness.

Researchers have achieved some results in the research of vibration and noise reduction of PM motors. For example, in a patent application “Analysis Method for Vibration and Noise Sources of Electric Vehicle Permanent Magnet Synchronous Motor in Wide Range Speed Regulation” with application number of CN201810458703.7, it discloses an analysis method for vibration and noise sources of electric vehicle permanent magnet synchronous motor in wide range speed regulation, which accurately analyzes the vibration and noise of permanent magnet synchronous motor for vehicles, but this method is not applicable to FSCW PM motor with more abundant electromagnetic force harmonic components. In a patent application “A Stator Structure for Weakening the Vibration of Permanent Magnet Motor” with application number of CN201721087818.7, it discloses a new stator structure for weakening the vibration of PM motor, including: motor base, damping layer and stator core. The damping layer is arranged between the motor base and the stator core. This method blocks the vibration transmission path of the motor, rather than suppressing the vibration source of PM motor. In a patent application “Calculation Method of Electromagnetic Vibration Noise of a Motor” with application number of CN201811227208.1, it discloses a calculation method of electromagnetic vibration noise of a motor, but this method does not propose a vibration and noise suppression method of PM motor. In a patent application “A Fractional Slot Concentrated Winding Permanent Magnet Motor with Low Vibration and Noise Performance and Its Design Method” with application number of CN201710849041.1, it discloses a FSCW PM motor with low vibration and noise performance and its design method. On the basis of the original slot-pole combination, the design method correspondingly adds several additional stator teeth to effectively reduce the noise performance of the PM motor. However, this method increases the difficulty of motor manufacturing and greatly affects the output torque performance of the motor. In addition, this method is only applicable to specific slot-pole combination and winding type, so it is not a universal method.

### SUMMARY

The purpose of the present disclosure is to provide a method for reducing the electromagnetic vibration of a FSCW PM motor. The present disclosure mainly includes deriving the mathematical expression of the electromagnetic force modulation effect of the PM motor based on the Nyquist Shannon sampling theorem. It mainly includes deriving the mathematical expression of electromagnetic force modulation effect of permanent magnet motor based on Nyquist Shannon sampling theorem; evaluating the electromagnetic force component that contributes the most to the FSCW PM motor; establishing the equivalent model of PM flux density, and is deducing the phase relationship between different magnetic flux density harmonics; according to Maxwell stress equation, getting the relationship between magnetic flux density harmonics and main electromagnetic force harmonics, and getting phase relationship between different electromagnetic force harmonics; designing a new magnet structure of the PM motor, and the magnetic flux density harmonic content in the PM motor is used to effectively reduce the electromagnetic force amplitude; and establishing a multi-physical electromagnetic vibration simulation model to verify the electromagnetic vibration suppression effect of the PM motor. On the premise of not increasing the processing difficulty and cost, an effective scheme to reduce the electromagnetic vibration of PM motor by using magnetic field harmonics is proposed.

Technical solution: In order to realize the purpose of the present disclosure, the technical solution adopted by the present disclosure is as follows:

The present disclosure provides a method for reducing the electromagnetic vibration of a FSCW PM motor, which includes the following steps:

The present disclosure provides a method for reducing the electromagnetic vibration of a FSCW PM motor, which includes the following steps:

Step 1. Based on Nyquist Shannon sampling theorem, the mathematical expression of electromagnetic force modulation effect of permanent magnet motor is derived.

Step 2. The electromagnetic force component that contributes the most to the FSCW PM motor is evaluated.

Step 3. The equivalent model of PM flux density is established, and the phase relationship between different harmonics of flux density is deduced.

Step 4. According to Maxwell stress equation, the relationship between flux density harmonics and main electromagnetic force harmonics is obtained, and the phase relationship between electromagnetic force harmonics is obtained.

Step 5. The new magnet structure of the PM motor is designed, and the harmonic content of the flux density in the PM motor is used to effectively reduce the amplitude of the resultant electromagnetic force.

Step 6. A multi-physical field electromagnetic vibration simulation model is established to verify the electromagnetic vibration suppression effect of the PM motor.

Furthermore, in step 1, the mathematical expression of the radial force modulation effect of the PM motor is derived according to the Nyquist Shannon sampling theorem. First, Fourier transform is performed on the air gap radial force density harmonic, and then Fourier decomposition is performed on the sampled signal. The output signal of the modulated radial force density can be expressed as the multiplication of the radial force density and the sampled signal, and the modulated radial force density can be expressed by using the frequency domain convolution theorem. According to the Nyquist Shannon sampling theorem, when the spatial order of the radial electromagnetic force is greater than half of the number of stator teeth, the spatial order of the radial electromagnetic force will change, and the high order electromagnetic force can be modulated into the low order electromagnetic force component.

Furthermore, in step 2, the motor stator is equivalent to a cylinder structure, and the mathematical relationship between the vibration displacement of the PM motor and the spatial order of the electromagnetic force can be obtained. When the spatial order of the electromagnetic force v≥2, the vibration displacement of the equivalent cylinder is approximately inversely proportional to the fourth power of the spatial order of the electromagnetic force. Therefore, the influence of electromagnetic force with higher spatial order on vibration is usually ignored. According to the relevant conclusion of claim 2, high-order electromagnetic force harmonics can be modulated into lower order electromagnetic force components. The contribution of electromagnetic force harmonics with small amplitude and low order and with large amplitude and high order to motor vibration are compared.

Furthermore, in step 3, the PM flux density waveform is approximately equivalent to a square wave signal to obtain the spatial order of the flux density harmonics and the corresponding phase angle. Since the square wave signal satisfies Dirichlet condition, Fourier coefficient of square wave signal can be obtained. As a consequence, the spatial order and the corresponding phase angle of the PM radial flux density harmonics can be obtained. Since the phase angle of the PM radial flux density harmonic is π/2 rad ahead of the tangential flux density harmonic, the spatial order and phase angle of the PM tangential flux density harmonic can be obtained. According to Fourier coefficient of square wave signal, the phase relationship between different PM flux density harmonics is obtained.

Furthermore, in step 4, the phase relationship between the main electromagnetic force harmonic components is obtained, and the relationship between the magnetic flux density harmonics and main electromagnetic force harmonics are obtained. According to Maxwell stress tensor method, the mathematical relationship between radial and tangential electromagnetic force and radial and tangential flux density harmonics can be expressed. Since the flux density is a function with time and space as variables, the electromagnetic force harmonics have a specific spatial order, frequency and initial phase angle. The electromagnetic force harmonics with the same spatial order and frequency have different initial phase angles, so there is superposition or cancellation between these electromagnetic force harmonics. According to Maxwell tensor method, the relationship between flux density harmonics and main electromagnetic force harmonics, as well as the phase relationship between different electromagnetic force harmonics can be obtained.

Furthermore, in step 5, the new magnet structure of the PM motor is designed, and the amplitude of the radial force is reduced by using the flux density harmonics in the PM motor. According to claim 5, there is phase superposition or cancellation between electromagnetic force harmonics. By analyzing the flux density harmonic source of the electromagnetic force component that plays the role of counteraction, each magnet is divided into three sections, and the remanence of the PM material at both ends is higher than that in the middle, so as to achieve the effect of flux density harmonic injection. The electromagnetic force generated by the injected PM flux density harmonics counteract the electromagnetic force generated by the fundamental flux density, so as to reduce the resultant electromagnetic force and electromagnetic vibration.

Furthermore, in step 6, a multi-physical field electromagnetic vibration simulation model is established to verify the electromagnetic vibration suppression effect of the PM motor. Two kinds of field numerical calculation software (i.e., Flux and LMS Virtual. Lab Acoustics) will be used cooperatively to carry out the simulation of electromagnetic vibration and noise of the PM motor. Flux is an excellent electromagnetic finite element simulation software for motor, which has the characteristics of convenient modeling, fast simulation speed and good adaptive subdivision effect. The modeling efficiency and the simulation accuracy are relatively high. After setting various parameters of the optimized FSCW PM motor in Flux, the force vector data derived from it can be connected with the vibration and noise simulation software LMS Virtual Lab Acoustics. LMS Virtual. Lab Acoustics can directly use CATIA, CAD and other models, and the geometric format is completely consistent. From the analysis of radial electromagnetic force and vibration mode of the motor, the electromagnetic analysis and three-dimensional structural dynamics simulation model of the PM motor are established. The flux density and radial electromagnetic force in the air gap of the PM motor are calculated by Maxwell stress method, and the spectrum analysis is performed. The structural vibration mode and harmonic response of the motor are analyzed by using the ANSYS finite element simulation software, and the relationship between the harmonic spectrum of the radial electromagnetic force of the motor and the main vibration modes (i.e., the low order vibration mode) of the motor is studied. The vibration is predicted, and the electromagnetic vibration suppression effect of the PM motor is verified.

Advantages of the Present Disclosure Include:

1. In the present disclosure, based on the Nyquist Shannon sampling theorem, the electromagnetic force modulation effect in the motor is derived, which overcomes the misconception that the low order electromagnetic force plays a decisive role in the electromagnetic vibration of the FSCW PM motor. the harmonic component of the electromagnetic force that plays a major role in the electromagnetic vibration of the PM motor is established in the present disclosure. The present disclosure provides guidance for analyzing the characteristics of electromagnetic vibration and reducing the electromagnetic vibration of PM motor.

2. In the present disclosure, an equivalent analytical model of the PM flux density is established, and the phase relationship between different PM flux density harmonics is clarified.

3. In the present disclosure, according to Maxwell stress equation, the amplitude, frequency and phase of main electromagnetic forces generated by PM flux density harmonics can be obtained. At the same time, the phase relationship between the harmonics of PM flux density and the main electromagnetic force, as well as the phase relationship between different electromagnetic force harmonics can be obtained, so as to clarify the internal relationship between the PM flux density harmonics and the main electromagnetic force.

4. In the present disclosure, according to the internal correlation between the PM flux density harmonics and electromagnetic force, the flux density harmonic is injected by reasonably designing the magnet structure, and the electromagnetic force component generated by the injected flux density harmonic offsets part of the original electromagnetic force, thereby reducing the electromagnetic vibration of the PM motor.

5. In the present disclosure, the method for reducing the electromagnetic vibration of the PM motor is universal. It is easy to be realized, and it is conducive to the engineering and practicality.

### BRIEF DESCRIPTION OF THE DRAWINGS

FIG. 1 shows the two-dimensional model of the new 12-slot/10-pole FSCW PM motor.

FIG. 2 shows the schematic diagram of electromagnetic force modulation process.

FIG. 3 shows the comparison of vibration displacement generated by the 2^{nd}- and 10^{th}-order radial forces; wherein, (a) of FIG. 3 shows the 2^{nd}-order radial force, (b) of FIG. 3 shows the 10^{th}-order radial force.

FIG. 4 shows the waveform diagram of the equivalent PM flux density.

FIG. 5 shows the PM flux density and electromagnetic force phase distribution; wherein (a) of FIG. 5 shows flux density harmonics, (b) of FIG. 5 shows the 10^{th}-order electromagnetic force harmonics.

FIG. 6 shows the flux density waveform and its spectrum of PM motor; wherein (a) of FIG. 6 shows the waveform, (b) of FIG. 6 shows the spectrum.

FIG. 7 shows the schematic diagram of electromagnetic force density spectrum of two PM motors; wherein (a) of FIG. 7 shows the radial force density, (b) of FIG. 7 shows the tangential force density.

FIG. 8 shows the flowchart of electromagnetic vibration simulation of PM motor.

FIG. 9 shows the vibration acceleration spectrum of PM motor with traditional structure and new structure; wherein (a) of FIG. 9 is under the no-load condition, (b) of FIG. 9 is under the load condition.

### DETAILED DESCRIPTION OF THE EMBODIMENTS

In order to make the purpose, technical scheme and advantages of the present disclosure clearer, the present disclosure is further described in detail below in combination with the drawings and embodiments. It should be understood that the specific embodiments described herein are only used to explain the present disclosure and are not used to define the present disclosure.

The present disclosure takes the electromagnetic force modulation effect into account in the electromagnetic vibration analysis of the PM motor. The phase relationship between different PM flux density harmonics and between flux density harmonics and electromagnetic force are clarified. In addition, a new magnet structure for reducing the electromagnetic vibration of FSCW PM motor is proposed.

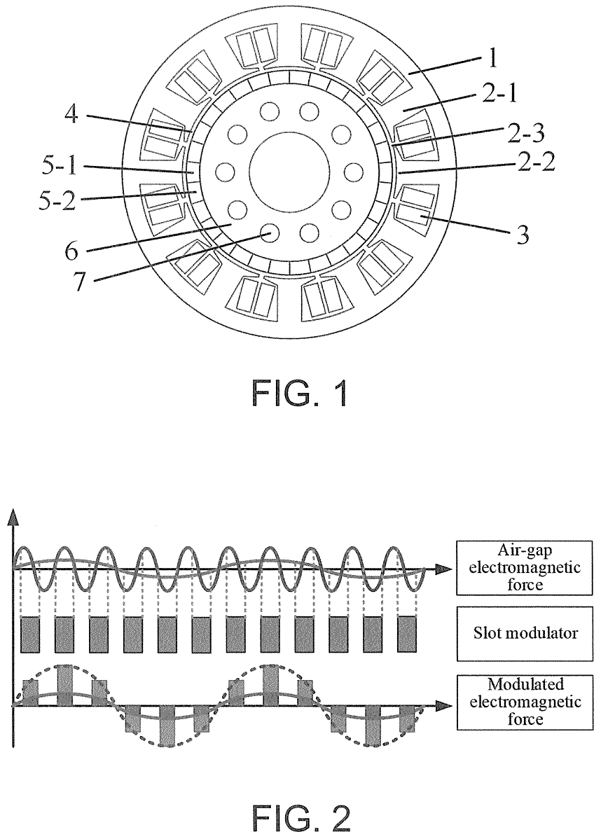

In order to more simply and clearly explain the beneficial effects of the present disclosure, a specific surface mounted permanent magnet motor is described in detail below. FIG. 1 is the topology structure of the proposed motor, in which 1 is the stator yoke, 2-1 is the stator tooth, 2-2 is the stator tooth pole shoe, 2-3 is the stator slot opening, 3 is the armature winding, 4 is the air gap between the stator and rotor, 5-1 is the segmented PM with smaller remanence, 5-2 is the segmented PM with larger remanence, 6 is the rotor core, 7 is the weight reduction hole of rotor core. The embodiment of the present disclosure is a three-phase surface mounted FSCW PM motor with 12-slots/10-poles, which consists of stator, air gap, PM and rotor core. The stator consists of stator yoke, stator tooth, stator tooth pole shoe, stator slot and armature winding. The material of the stator core is silicon steel sheet with a thickness of 0.35 mm. The armature winding topology is FSCW. The air gap is between the stator and rotor, and the air gap thickness is 1 mm; The material of the rotor core is silicon steel sheet with a thickness of 0.35 mm. The rotor is composed of PM and rotor core. The surface of the cylindrical rotor core is pasted with N42UH and N30UH PMs. The section of the surface pasted PM is approximately rectangular. Each magnet is divided into three parts. The remanence density of the N42UH magnets on both sides of each pole is higher than that of the middle N30UH magnet.

The specific implementation steps of the proposed method for reducing the electromagnetic vibration of the FSCW PM motor include,

Step 1. According to Nyquist Shannon sampling theorem, the expression of electromagnetic force modulation effect of PM motor is derived. First, Fourier transform on the air gap radial force density is performed, which can be expressed as

Pᵣ(v)=∫₀^{2π}pᵣ(θ,t)e^{-fvθ} (1)

where pᵣ is the radial force density, v is the spatial order of the radial force density, θ is the spatial position angle, and t is the time. Since the stator tooth sampling signal is periodic, the Fourier series of the stator tooth sampling signal can be expressed as

$$\\ \begin{matrix}z ( θ ) = {\sum }_{k = 1}^{Q} δ ( θ - k \frac{2 π}{Q} ) & ( 2 )\end{matrix}$$

where Q is the number of stator teeth, and k is a positive integer. Then Fourier decomposition of the sampled signal can be expressed as

$$Z ( v ) = F [ z ( θ ) ] = Q {\sum }_{k = 1}^{Q} δ ( v - kQ ) \qquad ( 3 )$$

Therefore, the output signal of the modulated radial force density can be expressed as

pₘ(θ,t)=pᵣ(θ,t)z(θ) (4)

According to the frequency domain convolution theorem, equation (4) can be expressed as

$${P}_{m} ( v ) = \frac{1}{2 π} {P}_{r} ( v ) * Z ( v ) \qquad ( 5 )$$

Substitute equation (1) and equation (3) into equation (5), and the modulated radial force density can be expressed as

$$\begin{matrix}{P}_{m} ( v ) = \frac{1}{2 π} [ Q {\sum }_{k = 1}^{Q} δ ( v - kQ ) * {P}_{r} ( v ) ] \\ = \frac{Q}{2 π} {\sum }_{k = 1}^{Q} {P}_{r} ( v - kQ )\end{matrix} \qquad ( 6 )$$

According to the Nyquist Shannon sampling theorem, when the spatial order of the radial electromagnetic force is greater than half of the number of stator teeth, the spatial order of the radial electromagnetic force will change. Therefore, the modulated radial force density can be expressed as

$$\{ \begin{matrix}{p}_{m} ( θ , t ) = {σ}_{v} cos ( v θ + {ω}_{v} t + {φ}_{v} ) & v \leq \frac{Q}{2} \\ {p}_{m} ( θ , t ) = {σ}_{v} cos ( ( v - kQ ) θ + {ω}_{v} t + {φ}_{v} ) & v > \frac{Q}{2}\end{matrix} \qquad ( 7 )$$

where pₘ is the modulated radial force density, σᵥ, ωᵥ and φᵥ is the amplitude, angular velocity and initial phase angle of the modulated radial force density. The radial force on the stator teeth can be equivalent to a concentrated force. The modulated radial force density on the stator teeth can be expressed as

$$\begin{matrix}{F}_{r , q} ( t ) = {\int }_{{θ}_{q} - \frac{Δ θ}{2}}^{{θ}_{q} + \frac{Δ θ}{2}} {p}_{m} ( θ , t ) d θ \\ = \{ \begin{matrix}{\int }_{{θ}_{q} - \frac{Δ θ}{2}}^{{θ}_{q} + \frac{Δ θ}{2}} {LR}_{is} [ {σ}_{r} cos ( v θ + {ω}_{v} t + {φ}_{v} ) ] d θ , & v \leq \frac{Q}{2} \\ {\int }_{{θ}_{q} - \frac{Δ θ}{2}}^{{θ}_{q} + \frac{Δ θ}{2}} {LR}_{is} [ {σ}_{r} cos ( ( v - kQ ) θ + {ω}_{v} t + {φ}_{v} ) ] d θ , & v > \frac{Q}{2}\end{matrix}\end{matrix} \qquad ( 8 )$$

where F_{r,q} is equivalent concentrated force, θ_{q} is the angle of the q^{th} stator tooth, Δθ is the tooth pitch, L is the lamination length of the stator, and Rᵢₛ is the inner radius of the stator. It can be seen from equation (7) and equation (8) that due to the limitation of the number of motor stator teeth, the high order radial force acting on the stator tooth surface are modulated into the low order radial force.

FIG. 2 is the modulation process of the 2^{nd}- and 10^{th}-order electromagnetic force harmonics of a 12-slot PM motor. The 2nd- and 10^{th}-order electromagnetic force harmonics are uniformly and continuously distributed in the air gap. However, when the electromagnetic forces distribute on stator tooth surface, the electromagnetic force will be discretized due to the slotting effect of the motor stator. As shown in FIG. 2, after the 2^{nd}-order radial force is modulated by 12 stator teeth, no aliasing occurs. However, when the 10^{th}-order radial force is modulated by 12 stator teeth, it presents a 2^{nd}-order distribution state in space.

Step 2. According to the vibration analytical model of the permanent magnet motor, the electromagnetic force component that contributes the most to the FSCW PM motor is evaluated. The stator of the motor is equivalent to a ring structure, so the electromagnetic vibration displacement of the PM motor can be expressed as

$$\{ \begin{matrix}{Y}_{vs} ( v = 0 ) = - \frac{{R}_{i} {R}_{y}}{{Eh}_{y}} {σ}_{v} \\ {Y}_{vs} ( v \geq 2 ) = \frac{12 {R}_{i} {R}_{y}^{3}}{{Eh}_{y}^{3} ( {v}^{2} - 1 )} {σ}_{v} \\ {Y}_{vd} = {{Y}_{vs} [ {( 1 - {ω}_{v}^{2} / {ω}_{m}^{2} )}^{2} + 4 {ξ}_{m}^{2} {ω}_{v}^{2} / {ω}_{m}^{2} ]}^{- 1 / 2}\end{matrix} \qquad ( 9 )$$

where, Yᵥₛ and Y_{vd} are static displacement and dynamic displacement generated by v-order radial electromagnetic force, σᵥ is the amplitude of v^{th}-order electromagnetic force, Rᵢ is the inner radius of the stator, R_{y} is the average radius of the stator yoke, h_{y} is the thickness of the stator yoke, and E is the Young's modulus of the equivalent ring, ωᵥ is the angular frequency of the v-order radial electromagnetic force, ωₘ and ξₘ is the natural frequency and damping ratio of the m^{th}-order mode, respectively. It can be seen from equation (9) that when the spatial order of the electromagnetic force v≥2, the vibration displacement of the equivalent cylinder is approximately inversely proportional to the fourth power of the spatial order of the electromagnetic force.

In the 12-slot/10-pole FSCW PM motor, the amplitude of the 10^{th}-order electromagnetic force is about 25 times that of the 2^{nd}-order electromagnetic force. According to the equivalent cylinder vibration model, their contribution to vibration can be expressed as

$$\frac{{Y}_{vs} ( v = 10 )}{{Y}_{vs} ( v = 2 )} = \frac{{( {2}^{2} - 1 )}^{2}}{{( {10}^{2} - 1 )}^{2}} \frac{{σ}_{v = 10}}{{σ}_{v = 2}} = 2.3 \% \qquad ( 10 )$$

Where, σᵥ=2 and σᵥ=10 is the amplitude of electromagnetic force of order 2 and order 10 respectively. The displacement caused by the 10th order force is only about 2.3% of the 2nd order force. Therefore, the influence of the 10th and higher order forces can be ignored. Therefore, the influence of electromagnetic force with higher spatial order on vibration is usually ignored. However, according to the conclusion of electromagnetic force modulation obtained from equation (7) and equation (8), the higher-order radial electromagnetic force can be modulated into the lower order radial electromagnetic force.

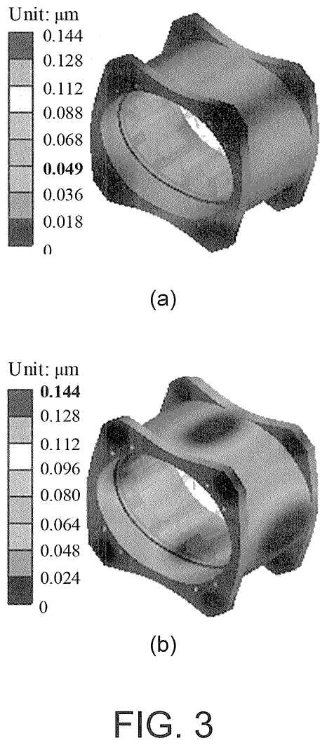

FIG. 3 compares the vibration displacement generated by the 2^{nd}- and 10^{th}-order electromagnetic forces of the 12-slot/10-pole FSCW PM motor. The vibration displacement generated by the second order electromagnetic force is 0.049 μm. The vibration displacement generated by the 10^{th}-order electromagnetic force is 0.144 μm. The 10^{th}-order electromagnetic force contributes more to the electromagnetic vibration of PM motor than the 2^{nd}-order electromagnetic force. The pole number order (i.e., 2p^{th}-order) electromagnetic force of FSCW PM motor has the largest amplitude, and the electromagnetic force modulation effect is of great significance to the electromagnetic vibration of PM motor.

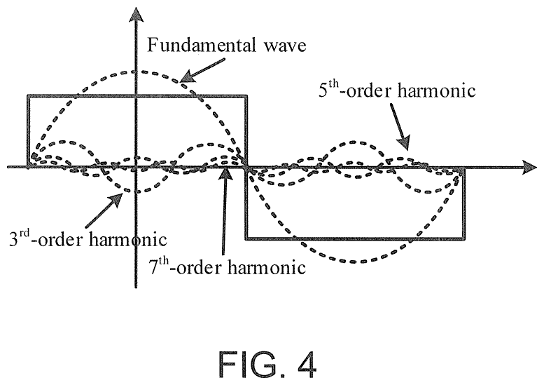

Step 3. The equivalent model of PM flux density is established, and the phase relationship between different PM flux density harmonics is derived. In order to obtain the spatial order and corresponding initial phase angle of the PM flux density harmonics, the waveform of PM flux density can be approximately equivalent to a square wave signal, as shown in FIG. 4. The square wave signal of equivalent PM flux density can be expressed as

$${B}_{eq - r} ( θ ) = \{ \begin{matrix}H , & 0 \leq θ \leq π / 2 \\ - H , & π / 2 < θ < 3 π / 2 \\ H , & 3 π / 2 \leq θ \leq 2 π\end{matrix} \qquad ( 11 )$$

where, B_{eq-r} is the equivalent PM flux density, H is the amplitude of the equivalent PM flux density, θ is the angular position. Since square wave signal satisfies Dirichlet condition, Fourier coefficient of the square wave signal can be expressed as

$$\{ \begin{matrix}{a}_{0} = \frac{1}{π} {\int }_{2 π}^{0} {B}_{eq - r} ( θ ) d θ = 0 \\ {a}_{n} = \frac{1}{π} {\int }_{2 π}^{0} {B}_{eq - r} ( θ ) cos ( n θ ) d θ = \{ \begin{matrix}\frac{4 H}{n π} , & n = 4 k - 3 \\ - \frac{4 H}{n π} , & n = 4 k - 1 \\ 0 , & n = 2 k\end{matrix} \\ {b}_{n} = \frac{1}{π} {\int }_{2 π}^{0} {B}_{eq - r} ( θ ) sin ( n θ ) d θ = 0\end{matrix} \qquad ( 12 )$$

where n is the spatial order of equivalent PM flux density. The spatial order and initial phase angle of the radial PM flux density harmonics can be expressed as

$${B}_{r - sl} = {B}_{r - mag} \cdot \{ \begin{matrix}{\sum }_{4 k - 3}^{∞} \frac{1}{4 k - 3} cos [ ( 4 k - 3 ) ( θ - 2 π {f}_{e} t ) ] + \\ {\sum }_{4 k - 1}^{∞} \frac{1}{4 k - 1} cos [ ( 4 k - 1 ) ( θ - 2 π {f}_{e} t ) + π ) ]\end{matrix} \} \qquad ( 13 )$$

where, Bᵣ₋ₛₗ is the slotless radial flux density, B_{r-mag} is the amplitude of the slotless radial flux density, fₑ is the electrical frequency and k is positive integer. Since the initial phase angle of the permanent magnet radial flux density harmonic is π/2 rad ahead of the tangential flux density harmonic, the tangential flux density harmonic can be expressed as

$${B}_{τ - sl} = {B}_{τ - mag} \cdot \{ \begin{matrix}{\sum }_{4 k - 3}^{∞} \frac{1}{4 k - 3} cos [ ( 4 k - 3 ) ( θ - 2 π {f}_{e} t ) + \frac{3 π}{2} ] + \\ {\sum }_{4 k - 1}^{∞} \frac{1}{4 k - 1} cos [ ( 4 k - 1 ) ( θ - 2 π {f}_{e} t ) + \frac{π}{2} ) ]\end{matrix} \} \qquad ( 14 )$$

where, B_{τ-sl} is the slotless tangential flux density, B_{τ-mag} is the amplitude of the slotless tangential flux density. The amplitude of the radial and tangential flux density harmonics is related to the geometric, electromagnetic and material parameters of the PM motor. It can be seen from equations (13) and (14) that the PM flux density only contains odd harmonics. Moreover, the initial phase difference of (4k−3)^{th}- and (4k−1)^{th}-order magnetic flux density harmonics is π rad phase angle. In addition, the tangential flux density lags behind the radial flux density π/2 rad phase angle. The initial phase of the PM radial and tangential flux density harmonics is shown in the table below.

TABLE 1
Phase angle of different PM flux density harmonics

| Spatial order | p | 3p | 5p | 7p | . . . | (4k-3)p | (4k-1)p |
|---|---|---|---|---|---|---|---|
| Radial flux density | 0 | π | 0 | π | | 0 | π |
| Tangential flux density | 3π/2 | π/2 | 3π/2 | π/2 | | 3π/2 | π/2 |

Step 4. The phase relationship between the main electromagnetic force harmonic components is obtained, and the relationship between the flux density harmonics and the 2p^{th}-order electromagnetic force harmonics is obtained.

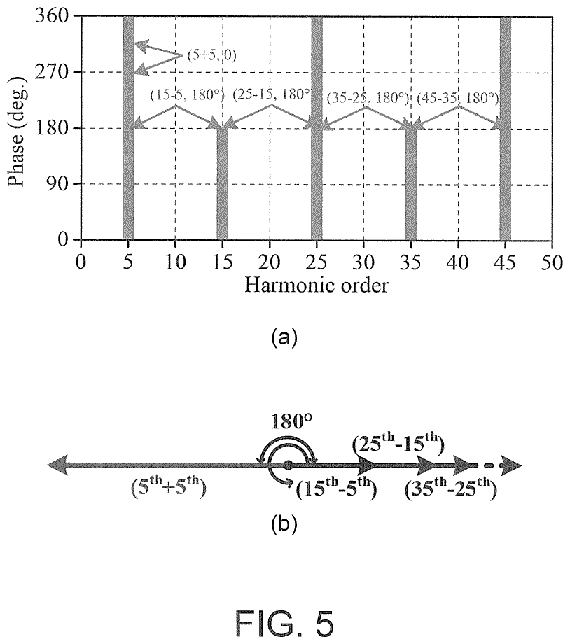

According to Maxwell stress tensor method, radial and tangential force density can be expressed as

$$\{ \begin{matrix}{p}_{r} ( θ , t ) = \frac{{B}_{r}^{2} ( θ , t ) - {B}_{τ}^{2} ( θ , t )}{2 {μ}_{0}} \approx \frac{{B}_{r}^{2} ( θ , t )}{2 {μ}_{0}} \\ {p}_{τ} ( θ , t ) = \frac{{B}_{r} ( θ , t ) \cdot {B}_{τ} ( θ , t )}{{μ}_{0}}\end{matrix} \qquad ( 15 )$$

Where pᵣ and p_{τ} are radial and tangential forces, Bᵣ and B_{τ} are the radial flux density and tangential flux density, μ₀ is the vacuum permeability. Since the amplitude of tangential flux density is relatively small, it is generally ignored when calculating the radial force. The air gap magnetic field of PM motor at no-load is composed of PM radial flux density and tangential flux density. The Fourier series expansion of the magnetomotive forces of radial and tangential are expressed as

$$\{ \begin{matrix}{F}_{r} ( θ , t ) = {\sum }_{{v}_{r} - 1 , 3 , 5}^{∞} {F}_{r - mag} cos ( {v}_{r} p θ - 2 π {v}_{r} {f}_{e} t + {φ}_{{v}_{r}} ) \\ {F}_{τ} ( θ , t ) = {\sum }_{{v}_{τ} - 1 , 3 , 5}^{∞} {F}_{τ - mag} cos ( {v}_{τ} p θ - 2 π {v}_{τ} {f}_{e} t + {φ}_{{v}_{τ}} )\end{matrix} \qquad ( 16 )$$

where Fᵣ and F_{τ} are the radial and tangential magnetomotive force, F_{r-mag} and F_{τ-mag} are the amplitude, vᵣ and v_{τ} are the spatial order, φᵥᵣ and φ_{vτ} are the initial phase angle. Due to the influence of stator slotting, the air gap permeance is no longer a constant. The air gap permeance can be expressed by a relative permeance function, whose Fourier series can be expressed as

$$λ ( θ ) = {λ}_{0} + {\sum }_{k = 1 , 2 , 3 …}^{∞} {λ}_{k} cos ( kQ θ ) \qquad ( 17 )$$

Where, λ is the air gap permeance, λₖ is the k-order air gap permeance, λ₀ is the DC component of air gap permeance, and Q is the number of stator slots. Therefore, the radial and tangential PM flux density can be expressed as

$$\begin{matrix}{B}_{r} = {F}_{r} \cdot λ \\ = {\sum }_{{v}_{r}} {F}_{r} cos ( {v}_{r} p θ - 2 π {v}_{r} {f}_{e} t + {φ}_{r} ) [ {λ}_{0} + {\sum }_{k = 1 , 2 , 3} {λ}_{k} cos ( kQ θ ) ] \\ = {\sum }_{{v}_{r}} {B}_{r} cos ( {v}_{r} p θ - 2 π {v}_{r} {f}_{e} t + {φ}_{r} ) + \\ {\sum }_{k = 1}^{∞} {\sum }_{{v}_{r}} {B}_{rk} cos [ ( {v}_{r} p \pm kQ ) θ - 2 π {v}_{r} {f}_{e} t + {φ}_{r} ]\end{matrix} \qquad ( 18 )$$

$$\begin{matrix}{B}_{τ} = {F}_{τ} \cdot λ \\ = {\sum }_{{v}_{τ}} {F}_{τ} cos ( {v}_{τ} p θ - 2 π {v}_{τ} {f}_{e} t + {φ}_{τ} ) [ {λ}_{0} + {\sum }_{k = 1 , 2 , 3} {λ}_{k} cos ( kQ θ ) ] \\ = {\sum }_{{v}_{τ}} {B}_{τ} cos ( {v}_{τ} p θ - 2 π {v}_{τ} {f}_{e} t + {φ}_{τ} ) + \\ {\sum }_{k = 1}^{∞} {\sum }_{{v}_{τ}} {B}_{τ k} cos [ ( {v}_{τ} p \pm kQ ) θ - 2 π {v}_{τ} {f}_{e} t + {φ}_{τ} ]\end{matrix} \qquad ( 19 )$$

where Fᵣ and F_{τ} are the radial and tangential magnetomotive force, vᵣ and v_{τ} are the spatial order, φᵥᵣ and φ_{vτ} are the initial phase angle, fₑ is the electrical frequency, p is the pole-pair number, λ is the air gap permeance, λₖ is the k-order air gap permeance, λ₀ is the DC component of air gap permeance, and Q is the number of stator slots. By substituting equation (18) and equation (19) into equation (15), the spatial order, frequency and initial phase of radial force and tangential force can be obtained. Both radial force harmonics and tangential force harmonics are generated by the interaction of flux density harmonics. According to the multiplication law of trigonometric function, the spatial order, frequency and initial phase of electromagnetic force harmonics are determined from the flux density harmonics. For FSCW PM motor, the phase difference between the radial force component generated by the PM flux density harmonic and by the fundamental flux density is π rad. FIG. 5 is the phase relationship between the PM flux density harmonics and the 10^{th}-order radial electromagnetic force. Except that the initial phase of the 10^{th}-order radial force generated by the fundamental flux density is 0, the initial phase of the 10^{th}-order radial force generated by the flux density harmonic is π rad. The phase relationship of the 10^{th}-order radial force generated by different PM flux density harmonics is shown in FIG. 5(b). In addition, the relationship between different PM flux density harmonics and the spatial order, frequency and phase of the 2p^{th}-order radial and tangential electromagnetic force are shown in Table 2.

TABLE 2
Relationship between different PM flux density harmonics and 2p^{th}-order radial
and tangential electromagnetic force

| Radial flux density | Tangential flux density | Radial force | Tangential force |
|---|---|---|---|
| (p, f^{ₑ}, 0) | (p, fₑ, 3π/2) | (p + p, 2fₑ, 0) | (p + p, 2fₑ, 3π/2) |
| (3p, 3fₑ, π) | (3p, 3fₑ, π/2) | (3p − p, 2fₑ, π) | (3p − p, 2fₑ, π/2) |
| (5p, 5fₑ, 0) | (5p, 5fₑ, 3π/2) | (5p − 3p, 2fₑ, π) | (5p − 3p, 2fₑ, π/2) |
| (7p, 7fₑ, π) | (7p, 7fₑ, π/2) | (7p − 5p, 2fₑ, π) | (7p − 5p, 2fₑ, π/2) |
| . . . | . . . | . . . | . . . |
| ((4k-3)p, 4k-3)fₑ, 0) | ((4k-3)p, (4k-3)fₑ, 3π/2) | ((4k-3)p-(4k-5)p, 2fₑ, π) | ((4k-3)p-(4k-5)p, 2fₑ, π/2) |
| ((4k-1)p, (4k-3)fₑ, π) | ((4k-1)p, (4k-3)fₑ, π/2) | ((4k-1)p-(4k-3)p, 2fₑ, π) | ((4k-1)p-(4k-3)p, 2fₑ, π/2) |

Base on the table, the phase difference of the 2p^{th}-order radial and tangential electromagnetic forces generated by the harmonics and fundamental waves of the PM flux density is π rad. Therefore, the of PM flux density harmonics can reduce the amplitude of 2p^{th}-order radial and tangential electromagnetic force, which provides guidance for the electromagnetic vibration suppression of FSCW PM motor.

Step 5. The new magnet structure of the PM motor is designed, and the flux density harmonic content in the PM motor is used to effectively reduce the amplitude of electromagnetic force.

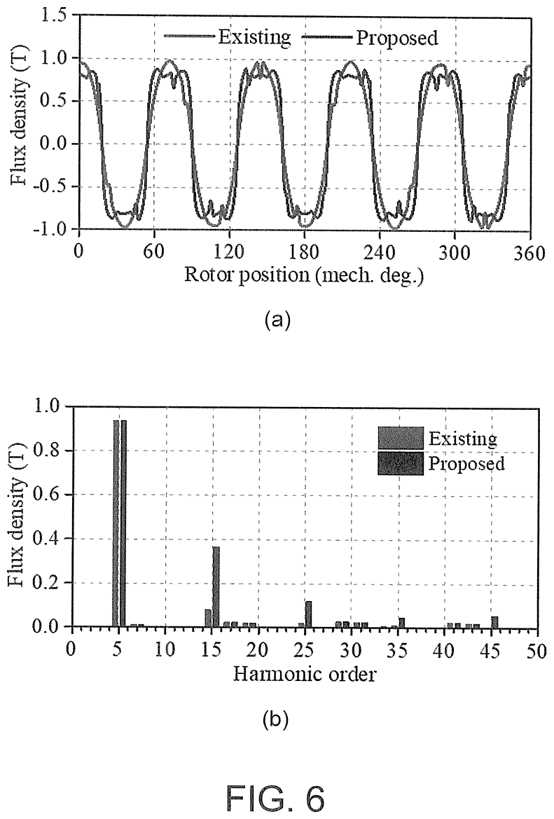

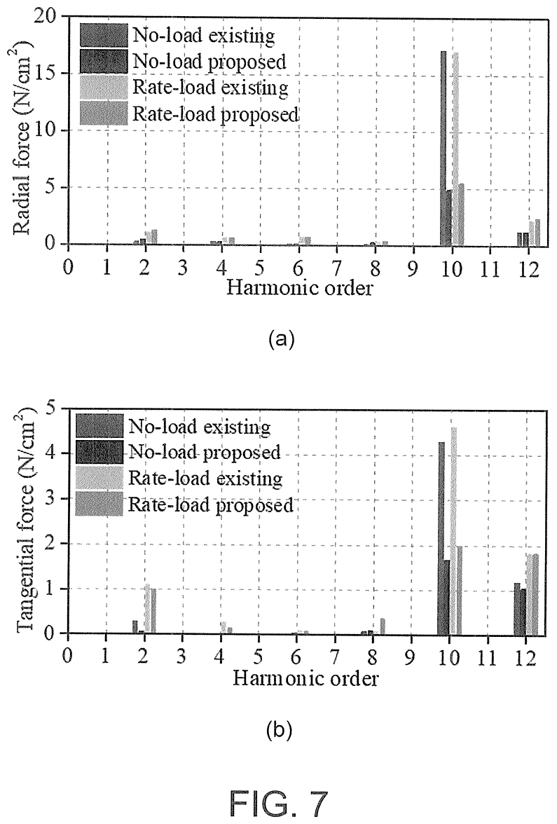

The phase relationship between the harmonics of magnetic flux density is obtained, and the relationship between the flux density harmonics and the main electromagnetic force harmonics, which can guide the low electromagnetic vibration design of PM motor. It can be seen from step 3 that for FSCW PM motor, the PM flux density harmonics are conducive to reducing the radial force and electromagnetic vibration of the PM motor. Each permanent magnet is divided into three sections, and the remanence of the permanent magnet material at both ends is higher than the remanence of the middle one, so as to achieve the effect of flux density harmonic injection. FIG. 6 is the flux density waveform and spectrum analysis of the 12-slot/10-pole PM motor with the proposed new magnet structure and with the traditional structure. The amplitude of the 15^{th}-, 25^{th}-, 35^{th}- and 45^{th}-order of flux density harmonics have been greatly increased, especially the amplitude of 15i-order flux density has increased to 0.36 T. The radial force generated by the injected PM flux density harmonic will counteract the electromagnetic force generated by the fundamental flux density. FIG. 7 shows the harmonic spectrum of radial and tangential electromagnetic forces of the 12-slot/10-pole FSCW PM motor with the traditional magnet structure and the new magnet structure under the no-load and load operation conditions of the PM motor. The amplitude of the 10^{th}-order radial and tangential electromagnetic force of the PM motor with the new magnet structure is effectively reduced both in the no-load and load conditions, which can effectively reduce the electromagnetic vibration of the PM motor.

Step 6. The electromagnetic vibration multiple-physical fields simulation model of the PM motor is established to verify the effectiveness of electromagnetic vibration reduction by the proposed method.

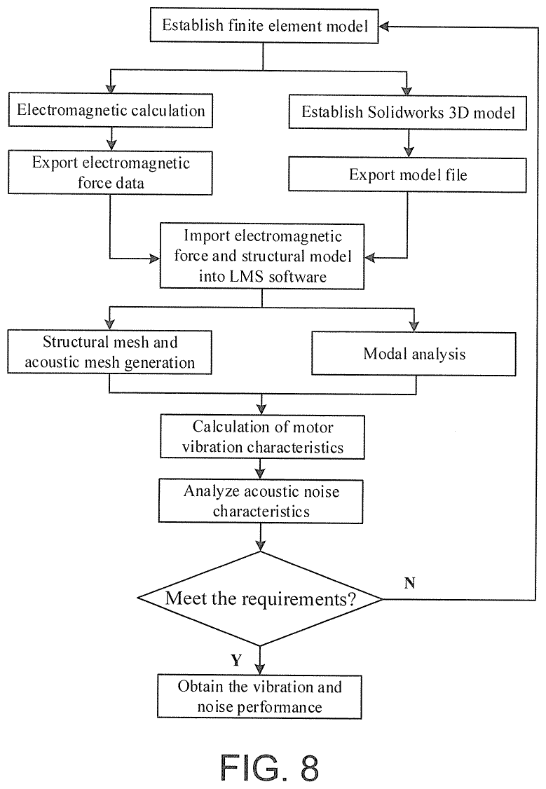

In order to verify the effect of suppressing electromagnetic vibration of FSCW PM motor, two kinds of numerical software (i.e., Flux and LMS Virtual Lab Acoustics) are used in the present disclosure to carry out the simulation calculation of electromagnetic vibration of PM motor. The software Flux is an excellent electromagnetic finite element simulation software for PM motor, which has the characteristics of convenient modeling, fast simulation speed and good adaptive subdivision effect. The modeling efficiency and the simulation accuracy is relatively high. In addition, the calculated electromagnetic force data can be seamlessly imported into the vibration and noise simulation software LMS Virtual Lab Acoustics. LMS Virtual Lab Acoustics is a professional vibration analysis software, which can provide a variety of solutions for acoustic analysis of PM motors. It can directly use CATIA, CAD and other models, and the geometric format is completely consistent. The powerful 1D/2D/3D grid generation function makes the electromagnetic vibration analysis of the PM motor more accurate. The finite element mesh is completely parallel to the geometric parameter model. When the geometric parameters are modified, the finite element mesh can be automatically updated. The simulation calculation process is shown in FIG. 8.

The present disclosure first analyzes the radial electromagnetic force and vibration mode of the PM motor, and establishes the electromagnetic analysis and 3D structural simulation model of the PM motor. The air gap flux density and radial electromagnetic force are calculated by Maxwell stress method and the frequency spectrum analysis is performed. The structural vibration mode and harmonic response of the PM motor are calculated by using the ANSYS finite element simulation software. The relationship between the spectrums of the radial electromagnetic force and the main (low order) vibration modes of the motor is studied. The electromagnetic vibration performance is evaluated, and resonance is avoided. The calculated electromagnetic force and free vibration mode of the PM motor are introduced into the sound field simulation module to predict the noise radiation, which provides strong support for improving the design theory of low-noise high-performance PM motor system.

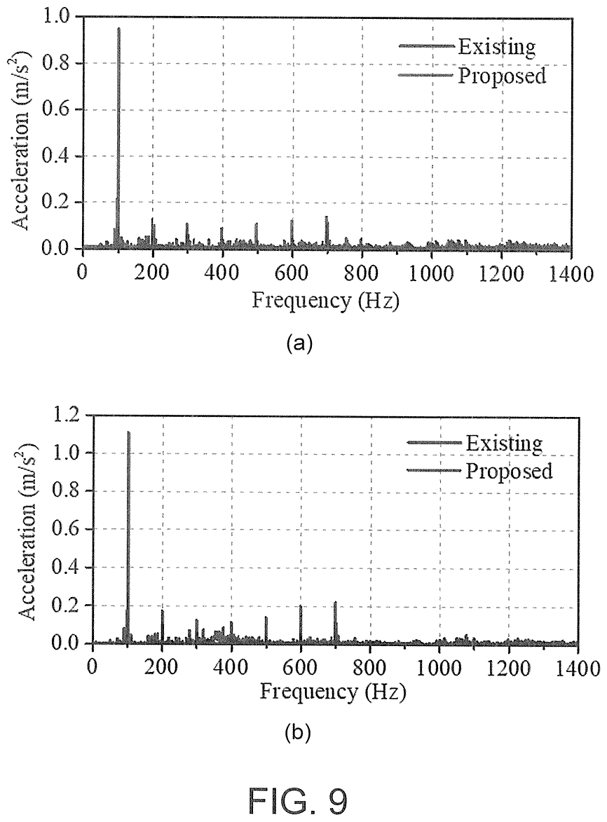

FIG. 9(a) shows the experimental vibration acceleration of a 12-slot/10-pole PM motor with traditional and new magnet structures under no-load conditions. The speed is 600 r/min, so the electrical frequency of the motor is 50 Hz. Since the frequency of electromagnetic force harmonic is distributed in the 2-, 4-, 6- and 8-times frequency, the vibration acceleration at these frequencies also has a large amplitude. In particular, the vibration acceleration of the traditional 12-slot/10-pole FSCW PM motor at the 2 times frequency is particularly serious. The 12-slot/10-pole FSCW PM motor of the new designed structure in the present disclosure significantly reduces the 10^{th}-order radial force and tangential forces. At the same time, the vibration of the proposed 12-slot/10-pole FSCW PM motor is also effectively reduced.

FIG. 9(b) is the experimental vibration acceleration of the 12-slot/10-pole FSCW PM motor with traditional and new designed structures under the rated load condition. Under the rated load condition, the amplitude of the 2^{nd}-order radial force and tangential forces increase significantly due to the rich armature magnetomotive force harmonics. Therefore, the vibration acceleration of the PM motor is also increased. As shown in FIG. 9, the main vibration source of the FSCW PM motor is the 10^{th}-order electromagnetic force, which generates a large vibration response due to the electromagnetic force modulation effect. Therefore, the flux density harmonic injection design of the new magnet structure PM motor in the present disclosure is significantly effective for vibration suppression.

1. A method for reducing electromagnetic vibration of a fractional slot concentrated winding (FSCW) permanent magnet (PM) motor, comprising:
step 1: based on Nyquist Shannon sampling theorem, a mathematical expression of an electromagnetic force modulation effect of the FSCW PM motor is derived;
step 2: a contribution of each order of electromagnetic force to an electromagnetic vibration of a FSCW PM motor is evaluated, and a harmonic component of an electromagnetic force that plays a major role in the electromagnetic vibration of the FSCW PM motor is identified;
step 3: an equivalent model of a PM flux density is established, and a phase relationship between harmonics of different magnetic flux density is explored;
step 4: according to Maxwell stress equation, a relationship between the flux density harmonics and a main electromagnetic force harmonic is obtained, and a phase relationship between different electromagnetic force harmonic components is obtained;
step 5: a segmented magnet structure is designed, and a magnetic flux density harmonic in the FSCW PM motor are increased to reduce an amplitude of the electromagnetic force and the electromagnetic vibration,
wherein the step 5 specifically comprises:
there is a phase superposition or cancellation effect between electromagnetic force harmonics, and a magnetic flux density harmonic source of an electromagnetic force component that plays a cancellation role is identified;
in order to achieve an effect of a flux density harmonic injection, each magnet is divided into three sections, and a remanence of the PM material at both ends is higher than a remanence of a middle one;
an electromagnetic force generated by the harmonic of the injected flux density harmonics counteracts an electromagnetic force generated by the fundamental magnetic field, achieving an effect of reducing a synthesized radial electromagnetic force and the electromagnetic vibration; and
step 6: a multiphysics electromagnetic vibration simulation model is established, and an electromagnetic vibration suppression effect of the FSCW PM motor is verified.

2. The method for reducing the electromagnetic vibration of the FSCW PM motor according to claim 1, wherein
the FSCW PM motor is a three-phase surface-mounted PM motor with 12 slots and 10 poles, including a stator, an air gap, and a rotor,
the stator includes a stator yoke, stator teeth, stator teeth pole shoes, stator slots between the stator teeth, and armature windings inside the stator slot,
a material of the stator core is silicon steel sheet and the armature windings adopt a fractional slot concentrated winding topology,
the air gap is between the stator and rotor, the rotor is evenly perforated, and a material of the rotor iron core is silicon steel sheet,
permanent magnets are attached to a surface of the cylindrical rotor iron core and a cross-section of the surface is rectangular, and
each magnet of the FSCW PM motor is blocked into three sections, wherein a residual flux density of the magnets on both sides of each pole is higher than a residual flux density of the middle one.

3. The method for reducing the electromagnetic vibration of the FSCW according to claim 1, wherein specific steps of the step 1 specifically comprises:
firstly, an air gap electromagnetic force harmonic is Fourier transformed, and then sampled signals are Fourier decomposed;
an output signal of a modulated electromagnetic force is expressed as a multiplication of an electromagnetic force density and the sampled signals, and the modulated electromagnetic force is expressed by using a frequency domain convolution theorem; and
according to the Nyquist Shannon sampling theorem, when a spatial order of the electromagnetic force is greater than half of a number of stator teeth, the spatial order of the electromagnetic force will change, and a higher-order electromagnetic force harmonic will be modulated into a lower order electromagnetic force components.

4. The method for reducing the electromagnetic vibration of the FSCW PM motor according to claim 1, wherein specific steps of the step 2 specifically comprises:
a stator of the FSCW PM motor is equivalent to a cylinder structure, and a mathematical relationship between the vibration displacement and an electromagnetic force spatial order of the FSCW PM motor is obtained;
when a spatial order of the electromagnetic force v≥2, the vibration displacement of an equivalent cylinder is approximately inversely proportional to a fourth power of the spatial order of the electromagnetic force;
therefore, the influence of electromagnetic force with high spatial order on vibration is ignored;
high order electromagnetic force harmonics are modulated into low order ones force harmonics; and
contributions of different electromagnetic force harmonics to electromagnetic vibration of the FSCW PM motor are evaluated and compared.

5. The method for reducing the electromagnetic vibration of the fractional slot concentrated winding permanent magnet motor according to claim 1, wherein specific steps of the step 3 specifically comprises:
a PM flux density waveform is approximately equivalent to a square wave signal, and a spatial order and a corresponding initial phase of the flux density harmonics are obtained;
since the square wave signal satisfies Dirichlet condition, Fourier coefficient of the square wave signal is obtained;
a spatial order of a PM radial flux density harmonic, and a corresponding initial phase angle, as well as the phase relationship between each flux density harmonic are obtained; and
since an initial phase angle of the PM radial flux density harmonic is π/2 rad ahead of a tangential flux density harmonic, a spatial order and an initial phase angle of a PM tangential flux density harmonic are obtained.

6. The method for reducing the electromagnetic vibration of the FSCW PM motor according to claim 1, wherein specific steps of the step 4 specifically comprises:
a phase relationship between harmonic components of a main electromagnetic force is obtained, and a mapping relationship between harmonic components of a magnetic flux density and harmonic components of the main electromagnetic force is obtained;
according to Maxwell stress tensor method, a mathematical relationship between radial and tangential electromagnetic forces and radial and tangential magnetic flux density is expressed;
since a magnetic flux density is a function of time and space, electromagnetic force harmonics of each order also have a specific spatial order, time frequency and initial phase angle;
electromagnetic force harmonics with a same spatial order and time frequency have different initial phase angles, so there is a superposition or cancellation effect between the electromagnetic force harmonics;
each order of magnetic flux density harmonics is expressed as a function of the spatial order, time frequency and initial phase angle; and
according to Maxwell tensor method, a mapping relationship between the magnetic flux density harmonics and the main electromagnetic force harmonic, and the phase relationship between electromagnetic force harmonic components are obtained.

7. (canceled)

8. The method for reducing the electromagnetic vibration of the FSCW PM motor according to claim 1, wherein specific steps of the step 6 specifically comprises:
a multiphysics field electromagnetic vibration simulation model is established, and the electromagnetic vibration suppression effect of the FSCW PM motor is verified;
two numerical software, Flux and LMS Virtual. Lab Acoustics, are used to simulate the electromagnetic vibration and a noise of the FSCW PM motor;
optimized parameters of the FSCW PM motor will be set in the Flux, which is an electromagnetic finite element simulation software, and force vector data of the FSCW PM motor are exported;
the force vector data are seamlessly connected to the LMS Virtual. Lab Acoustics, which is a vibration simulation software;
electromagnetic analysis and three-dimensional structural dynamics simulation models of the FSCW PM motor are established, and the electromagnetic force and a vibration mode of the FSCW PM motor are analyzed;
a structural vibration mode and a harmonic response of the FSCW PM motor are analyzed, and a relationship between radial electromagnetic force spectrum components and low order vibration modes of the FSCW PM motor are studied; and
a vibration performance of the FSCW PM motor is simulated, and the electromagnetic vibration suppression effect of the FSCW PM motor is verified.
